(19) United States
(12) Patent Application Publication
(10) Pub. No.: US 2010/0101364 A1
(43) Pub. Date: Apr. 29, 2010

(54) Steering Wheel With Pattern And Method For Manufacturing The Same

(75) Inventor: Frank Seidl, Tokyo (JP)

Correspondence Address: FITCH EVEN TABIN & FLANNERY, 120 SOUTH LASALLE STREET, SUITE 1600, CHICAGO, IL, 60603-3406, US

(73) Assignee: TAKATA CORPORATION, Tokyo (JP)

(21) Appl. No.: 12/596,538

(22) PCT Filed: Dec. 21, 2007
(86) PCT No.: PCT/JP2007/074655

§ 371 Date: Oct. 19, 2009

(30) Foreign Application Priority Data
Apr. 19, 2007 (JP) 2007-110110

(51) Int. Cl. B62D 1/04; G05G 1/10; B23P 17/00

(52) U.S. Cl. 74/552; 29/527.1

(57) ABSTRACT

A steering wheel is provided with a pattern in which design expressiveness can be improved and a method for manufacturing the same. In one form, the steering wheel includes a core metal extending along a substantially ring-shaped rim, a pad, and a spoke provided radially inward of the rim; and a synthetic-resin upper shell and lower shell that are formed of synthetic resin, whose surfaces are given a pattern, and which are provided along the outer circumference of the rim of the core metal so as to engage with each other. In this case, a synthetic resin layer is provided which coats the whole of at least the rim of the core metal by molding is provided, and the upper shell and the lower shell cover the synthetic resin layer that constitutes part of the rim so as to sandwich it therebetween.

### TECHNICAL FIELD

The present invention relates to steering wheels with a pattern and a method for manufacturing the same, and in particular, it relates to a steering wheel having a pattern, such as a woodgrain pattern, at part of the rim in the circumferential direction, as well as a method for manufacturing the same.

### BACKGROUND ART

In the related art, as a steering wheel with a pattern, a steering wheel having a wooden decorative piece around a rim except the vicinity of part of the rim, connected to spokes, has already been proposed (for example, Patent Document 1). In this steering wheel, a decorative portion that is formed by curving a lumber in the shape of the spokes is fixed to the main body of the wheel constituted of a core formed by die-casting and a urethane-resin coat.

[Patent Document 1] Japanese Patent Application Publication No. 2006-175890 (see FIG. 1)

### DISCLOSURE OF INVENTION

### Problems to be Solved by the Invention

Since the above-described steering wheel uses a decorative piece made of natural wood, it can express only natural grain patterns as its design, thus having poor design expressiveness.

An object of the present invention is to provide a steering wheel in which an artificial pattern can be expressed so that the expressiveness of a woodgrain pattern can be improved, as well as a method for manufacturing the same.

### Means for Solving the Problems

To achieve the above object, a first invention includes a core metal extending along a substantially ring-shaped rim, a pad, and a spoke provided radially inward of the rim; and an upper shell and a lower shell that are formed of synthetic resin, whose surfaces are given a pattern, and which are provided along the outer circumference of the rim of the core metal so as to engage with each other.

In the first invention, a second invention further includes a synthetic resin layer that coats the whole of at least the rim of the core metal by molding, wherein the upper shell and the lower shell cover the synthetic resin layer that constitutes part of the rim so as to sandwich the synthetic resin layer therebetween.

A third invention includes forming a synthetic resin layer by molding synthetic resin on a core metal extending along a substantially ring-shaped rim, a pad, and a spoke provided radially inward of the rim; forming an upper shell and a lower shell that cover the synthetic resin layer from synthetic resin; covering the synthetic resin layer with the upper shell and the lower shell and joining them together; and transferring a pattern onto the surfaces of the upper shell and the lower shell covering the synthetic resin layer by hydraulic transfer.

A fourth invention includes forming a synthetic resin layer by molding synthetic resin on a core metal extending along a substantially ring-shaped rim, a pad, and a spoke provided radially inward of the rim; forming an upper shell and a lower shell that cover the synthetic resin layer from synthetic resin; transferring a pattern onto the surfaces of the upper shell and the lower shell by hydraulic transfer; and covering the synthetic resin layer with the upper shell and the lower shell subjected to the hydraulic transfer and joining them together.

### ADVANTAGES

According to the first invention, the rim is constructed such that the upper shell and the lower shell are provided in engagement along the outer circumference of the core metal, and the surfaces of the upper shell and the lower shell are given a pattern. This allows an artificial pattern to be given without a limitation in design as in the case of using natural wood, thus improving design expressiveness. The time to give the pattern to the upper shell and the lower shell may either before or after the upper shell and the lower shell are disposed around the outer circumference of the core metal.

According to the second invention, the rim is constructed such that the synthetic resin layer is covered with the upper shell and the lower shell, and the surfaces of the upper shell and the lower shell are given a pattern. This allows an artificial pattern to be given without a limitation in design as in the case of using natural wood, thus improving design expressiveness. The time to give the pattern to the upper shell and the lower shell may either before or after the upper shell and the lower shell are mounted to the synthetic resin layer.

According to the third invention, the rim is constructed such that the synthetic resin layer is covered with the upper shell and the lower shell, and they are joined together, on which a pattern is hydraulically transferred. This allows an artificial pattern to be given without a limitation in design as in the case of using natural wood, thus improving design expressiveness. Moreover, since the hydraulic transfer is performed after the upper shell and the lower shell are joined in advance, the occurrence of discontinuity of the pattern at the joint surfaces of the upper shell and the lower shell can be prevented, thus improving the design.

According to the fourth invention, the rim is constructed such that the surface of the upper shell is given a pattern by hydraulic transfer, the surface of the lower shell is also given the pattern by hydraulic transfer, the synthetic resin layer is covered with these upper and lower shells with the pattern, and they are joined together. This allows an artificial pattern to be given without a limitation in design as in the case of using natural wood, thus improving design expressiveness. The upper shell and the lower shell (including the pattern transfer) may be completed by another process, and they may be mounted to the synthetic resin layer. That is, since the upper shell and the lower shell are separately subjected to the hydraulic transfer, it is easy to perform the hydraulic transfer, thus reducing manufacturing hours.

### BEST MODES FOR CARRYING OUT THE INVENTION

An embodiment of the present invention will be described below with reference to the drawings.

FIG. 1 is a front view of a steering wheel of the embodiment, with part partially cut away; FIG. 2 is an enlarged cross-sectional view taken along line A-A of the steering wheel in FIG. 1; and FIG. 3 is an enlarged cross-sectional view taken along line B-B of the steering wheel in FIG. 1.

In FIG. 1, the steering wheel 1 is equipped with a core metal 5 that is integrally formed along a pad 2, spokes 3, and a rim 4. Part of the spokes 3 and the whole circumference of the rim 4 along the core metal 5 are coated with a synthetic resin layer 6 from the outer circumference side by molding. The synthetic resin layer 6 is formed, as shown in FIG. 2, such that the cross-sectional area of a portion (an arc that constitutes three fourths of the whole circumference) S1 of the rim 4 is larger than the cross-sectional area of the other portion (an arc that constitutes one fourth of the whole circumference) S2. Here, the cross-sectional areas are areas of cross sections perpendicular to the circumferential direction of the rim 4, and the cross-sectional areas of the portions S1 and S2 have substantially similar figures. The portion S1 of the synthetic resin layer 6 is covered with leather 7. The portion S2 of the synthetic resin layer 6 is, as shown in FIG. 3, provided with an upper shell 8 and a lower shell 9 formed of synthetic resin in such a manner that they cover the synthetic resin layer 6 (in other words, around the outer circumference of the core metal 5) while engaging with each other, on the surface of which a woodgrain pattern 10 is formed.

This steering wheel 1 is manufactured in the following way.

FIG. 4 is a front view of the core metal 5; FIG. 5 is a front view of the steering wheel 1, with the upper shell 8 and the lower shell 9 exploded; and FIG. 6 is a flowchart describing a first embodiment of a method for manufacturing the steering wheel 1.

First, as shown in FIG. 4, the core metal 5 extending along the pad 2, the spokes 3, and the rim 4 is integrally formed by die-casting from an aluminum alloy or a magnesium alloy (FIG. 6, step S21).

The core metal 5 may be formed by separately forming core metals that constitute the pad 2, the spokes 3, and the rim 4 and connecting them by welding or the like.

Next, as shown in FIG. 5, the core metal 5 is placed in a mold (not shown), and polyurethane resin or the like is ejected around part of the spokes 3 and the whole circumference of the rim 4 to form the soft synthetic resin layer 6 (FIG. 6, step S22). This synthetic resin layer 6 is formed, as shown in FIG. 2, such that the cross-sectional area of the portion S1 around which the leather 7 is disposed is larger than the cross-sectional area of the portion S2 around which the woodgrain pattern 10 is disposed. Here, the cross-sectional areas are areas of cross sections perpendicular to the circumferential direction of the rim 4, and the cross-sectional areas of the portions S1 and S2 have substantially similar figures.

Next, as shown in FIG. 5, the synthetic resin layer 6 of the portion S1 of the rim 4 is covered with the leather 7 using an adhesive (step 23). It is preferable that the leather 7 be formed slightly longer than the portion S1, and as shown in FIG. 2, the ends be folded between tiers that constitute the boundaries between the portion S1 and the portion S2 of the synthetic resin layer 6.

Meanwhile, synthetic resin, such as polypropylene, is ejected into a form for forming the upper shell 8 and the lower shell 9 to thereby form the upper shell 8 and the lower shell formed of the hard synthetic resin (step 24). The upper shell 8 and the lower shell 9 are formed along the shape of the portion S2 to which the woodgrain pattern 10 is given, and a cross section perpendicular to the circular arc direction forms a semicircle. The joint surfaces (flat surfaces) of the upper shell 8 and the lower shell 9 have recessed portions 8a and 9a, respectively, having a shape corresponding to the synthetic resin layer 6.

The upper shell 8 and the lower shell 9 are put over the synthetic resin layer 6 so as to sandwich it therebetween, and their joint surfaces are bonded to each other with an adhesive (step 25). In this state, as shown in FIG. 2, the ends of the leather 7 are held in a folded state by the ends of the upper shell 8 and the lower shell 9. The upper shell 8 and the lower shell 9 may be bonded to the synthetic resin layer 6. Alternatively, it is also possible that the core metal 5 be formed in an appropriate form in advance and the upper shell 8 and the lower shell 9 be mounted to the core metal 5 (the synthetic resin layer 6 is omitted).

Next, the woodgrain pattern 10 is given to the surfaces of the upper shell 8 and the lower shell 9 by hydraulic transfer. The hydraulic transfer is such that a mask member is applied to one of the upper shell 8 and the lower shell 9, for example, the upper shell 8, and thereafter, the lower shell 9 is moved downward into contact with a transfer film floated in a water tank to thereby transfer the woodgrain pattern 10 of the transfer film onto the lower shell 9. Next, the mask member applied on the upper shell 8 is removed. Next, a mask member is applied to the lower shell 9, and thereafter, the upper shell 8 is moved downward into contact with the transfer film floated in the water tank to thereby transfer the woodgrain pattern 10 of the transfer film onto the upper shell 8 (step 26).

Next, the upper shell 8 and the lower shell 9 to which the woodgrain pattern 10 is given are coated with a transparent synthetic resin 11 for protecting the woodgrain pattern 10 (step 27).

According to this embodiment, the synthetic resin layer 6 is covered with the upper shell 8 and the lower shell 9 to constitute the rim, and the surfaces of the upper shell 8 and the lower shell 9 are given the woodgrain pattern 10 by hydraulic transfer. This allows an artificial pattern to be given without a limitation in design as in using natural wood, thus improving the design expressiveness. Furthermore, since the hydraulic transfer is performed after the upper shell 8 and the lower shell 9 are joined (different from a modification below), the occurrence of a discontinuous portion of the pattern at the joint portion between the upper shell 8 and the lower shell 9 can be prevented, thus improving the design.

The above-described steering wheel 1 may be manufactured not only by the above-described method but also in another procedure. FIG. 7 is a flowchart describing a method for manufacturing the steering wheel 1 according to such a modification.

First, as shown in FIG. 4, the core metal 5 extending over the pad 2, the spokes 3, and the rim 4 is integrally formed by die-casting from an aluminum alloy or a magnesium alloy (FIG. 7, step S31).

The core metal 5 may be formed by separately forming core metals that constitute the pad 2, the spokes 3, and the rim 4 and connecting them by welding or the like.

Next, as shown in FIG. 5, the core metal 5 is placed in a mold, and synthetic resin, such as polyurethane resin, is ejected around part of the spokes 3 and the whole circumference of the rim 4 to form the soft synthetic resin layer 6 (step S32). This synthetic resin layer 8 is formed, as shown in FIG. 3, such that the cross-sectional area of the portion S1 around which the leather 7 is disposed is larger than the cross-sectional area of the portion S2 around which the woodgrain pattern 10 is disposed. Here, the cross-sectional areas are areas of cross sections perpendicular to the circumferential direction of the rim 4, and the cross-sectional areas of the portions S1 and S2 have substantially similar figures.

Next, as shown in FIG. 5, the first synthetic resin layer 6 of the portion S1 of the rim 4 is covered with the leather 7 using an adhesive (step 33). It is preferable that the leather 7 be formed slightly longer than the portion S1, and as shown in FIG. 3, the ends be folded between tiers that constitute the boundaries between the portion S1 and the portion S2 of the synthetic resin layer 6.

Meanwhile, synthetic resin, such as polypropylene, is ejected into a form for forming the upper shell 8 and the lower shell 9 to thereby form the upper shell 8 and the lower shell 9 formed of the hard synthetic resin (step 34). The upper shell 8 and the lower shell 9 are formed along the shape of the portion S2 to which the woodgrain pattern 10 is given, and a cross section perpendicular to the circular arc direction forms a semicircle. The joint surfaces (flat surfaces) of the upper shell 8 and the lower shell 9 have recessed portions 8a and 9a, respectively, having a shape corresponding to the synthetic resin layer 6.

Next, the woodgrain pattern 10 is given to the surfaces of the upper shell 8 and the lower shell 9 by hydraulic transfer (step 35).

Next, the upper shell 8 and the lower shell 9 to which the woodgrain pattern 10 is given are coated with the transparent synthetic resin 11 for protecting the woodgrain pattern 10 (step 36).

The upper shell 8 and the lower shell 9 are put over the synthetic resin layer 6 so as to sandwich it therebetween, and their joint surfaces are bonded to each other with an adhesive (step 37). In this state, as shown in FIG. 2, the ends of the leather 7 are held in a folded state by the ends of the upper shell 8 and the lower shell 9. The upper shell 8 and the lower shell 9 may be bonded to the synthetic resin layer 6. Alternatively, it is also possible that the core metal 5 be formed in an appropriate form in advance and the upper shell 8 and the lower shell 9 be mounted to the core metal 5 (the synthetic resin layer 6 is omitted), as in the above.

This modification can also improve the design expressiveness by giving an artificial pattern, as in the above embodiment. The upper shell 8 and the lower shell 9 (including pattern transfer) may be completed by another process. That is, since the upper shell 8 and the lower shell 9 are separately subjected to hydraulic transfer, it is easy to perform the hydraulic transfer, thus reducing manufacturing hours.

The present invention is limited only to the scope of the claims; for example, part of the rim 4 other than the part along which the upper shell 8 and the lower shell 9 are disposed may be covered with a member other than the leather 7, may be given a pattern, or may be the synthetic resin layer 6 itself.

### BRIEF DESCRIPTION OF DRAWINGS

FIG. 1 is a front view a steering wheel of an embodiment, with part partially cut away.

FIG. 2 is an enlarged cross-sectional view taken along line A-A of the steering wheel in FIG. 1.

FIG. 3 is an enlarged cross-sectional view taken along line B-B in FIG. 1.

FIG. 4 is a front view of a core metal.

FIG. 5 is a front view of the steering wheel, with the upper shell and the lower shell exploded.

FIG. 6 is a flowchart describing an example of a method for manufacturing the steering wheel.

FIG. 7 is a flowchart describing another example of the method for manufacturing the steering wheel.

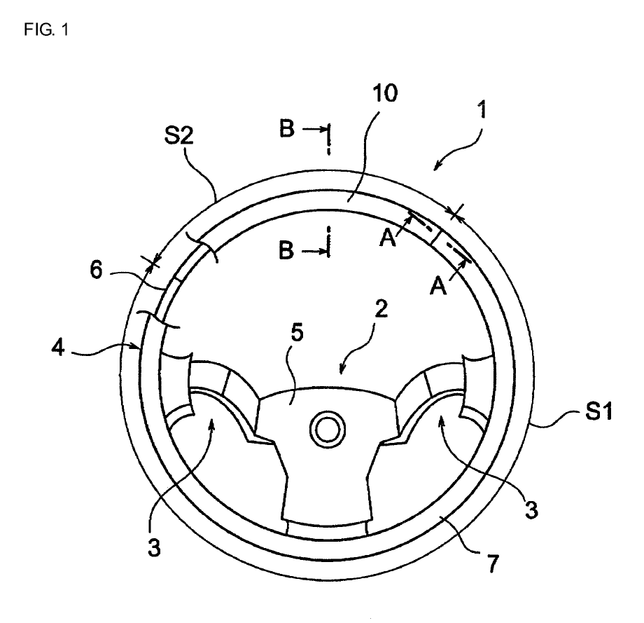

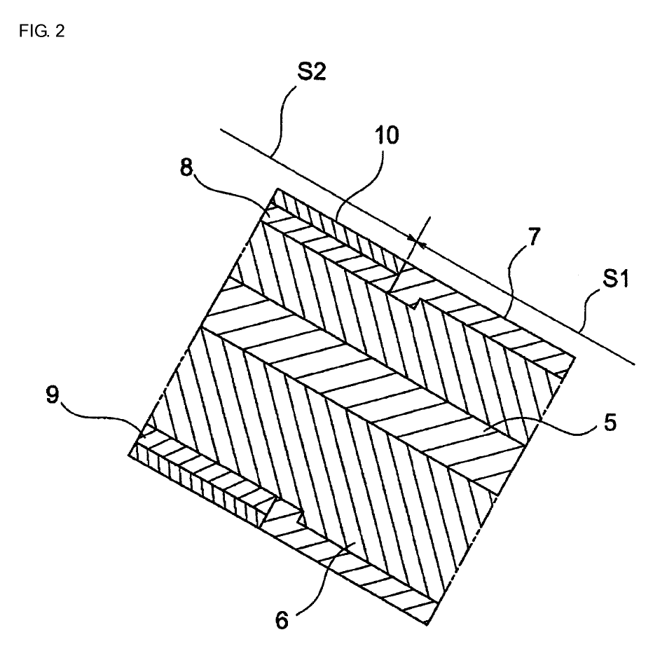

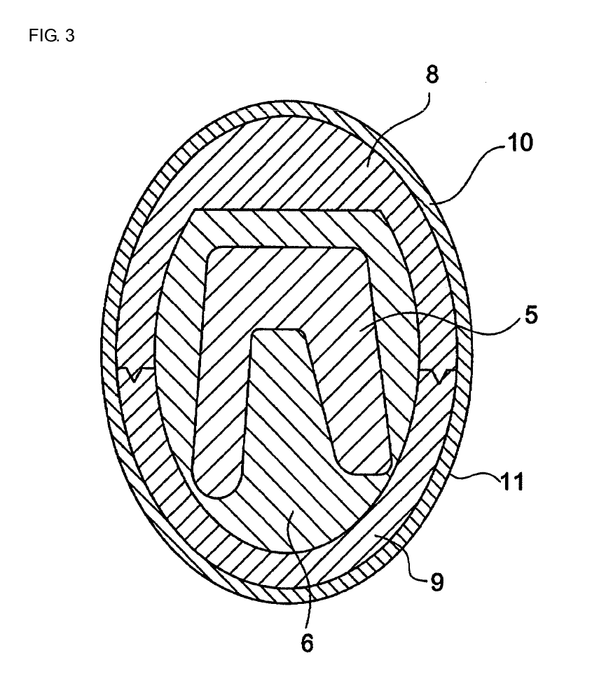

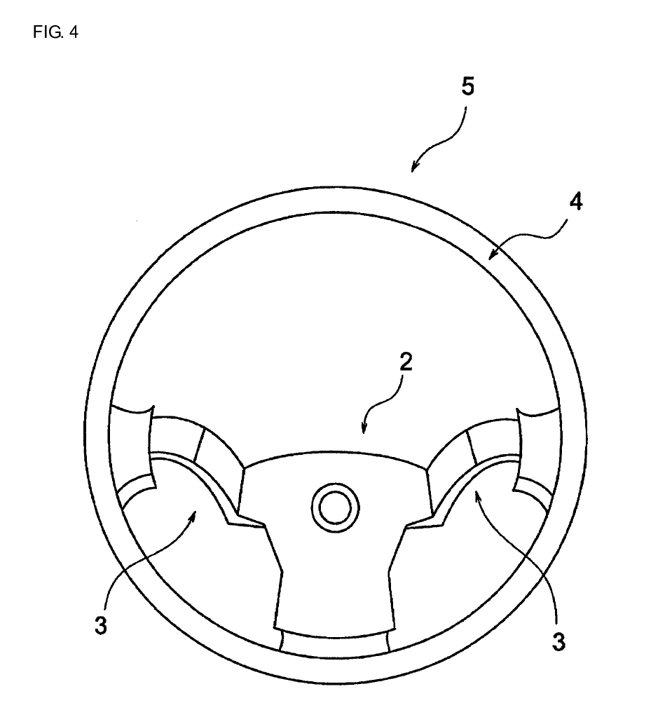

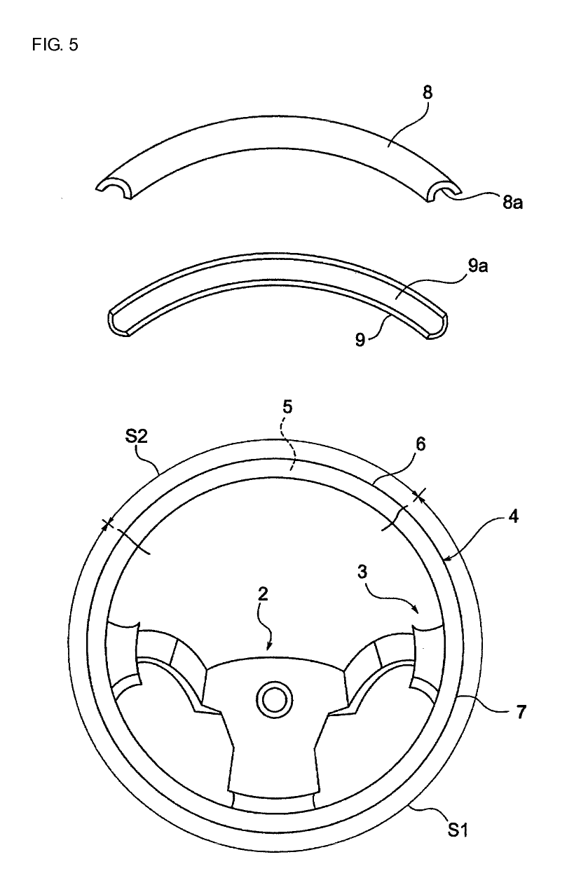

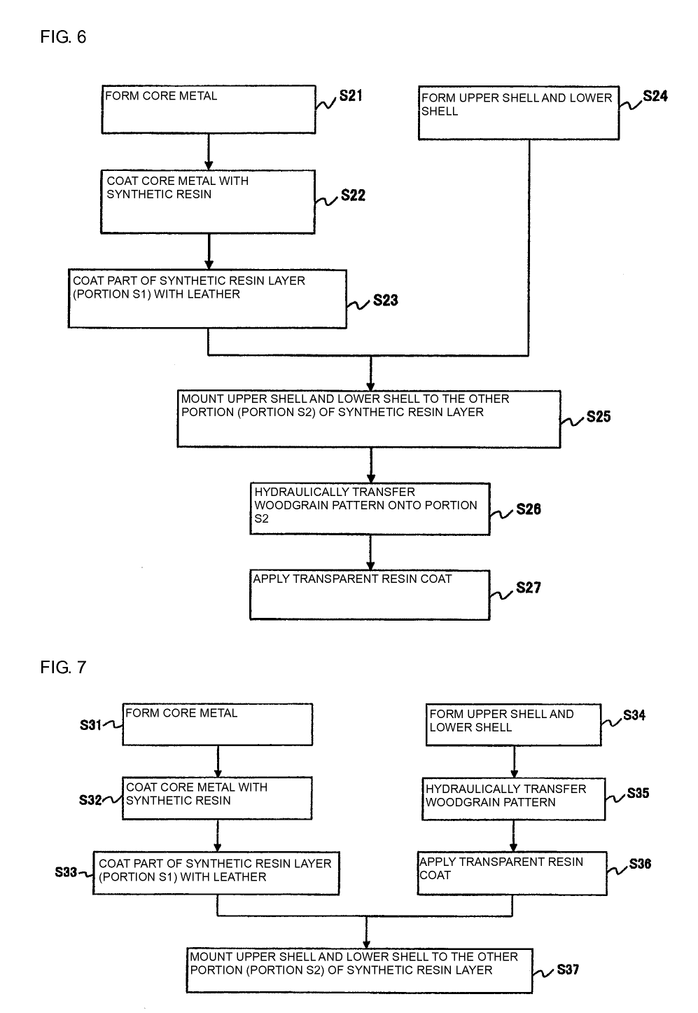

### REFERENCE NUMERALS

1 steering wheel
2 pad
3 spoke
4 rim
5 core metal
6 synthetic resin layer
7 leather
8 upper shell
9 lower shell
10 woodgrain pattern
11 transparent synthetic resin

1. A steering wheel with a pattern, comprising:
a core metal extending along a substantially ring-shaped rim, a pad, and a spoke provided radially inward of the rim; and
an upper shell and a lower shell that are formed of synthetic resin, whose surfaces are given a pattern, and which are provided along the outer circumference of the rim of the core metal so as to engage with each other.

2. The steering wheel according to claim 1, further comprising:
a synthetic resin layer that coats the whole of at least the rim of the core metal by molding,
wherein the upper shell and the lower shell cover the synthetic resin layer that constitutes part of the rim so as to sandwich the synthetic resin layer therebetween.

3. A method for manufacturing a steering wheel with a pattern, the method comprising:
forming a synthetic resin layer by molding synthetic resin on a core metal extending along a substantially ring-shaped rim, a pad, and a spoke provided radially inward of the rim;
forming an upper shell and a lower shell that cover the synthetic resin layer from synthetic resin;
covering the synthetic resin layer with the upper shell and the lower shell and joining them together; and
transferring a pattern onto the surfaces of the upper shell and the lower shell covering the synthetic resin layer by hydraulic transfer.

4. A method for manufacturing a steering wheel with a pattern, the method comprising:
forming a synthetic resin layer by molding synthetic resin on a core metal extending along a substantially ring-shaped rim, a pad, and a spoke provided radially inward of the rim;
forming an upper shell and a lower shell that cover the synthetic resin layer from synthetic resin;
transferring a pattern onto the surfaces of the upper shell and the lower shell by hydraulic transfer; and
covering the synthetic resin layer with the upper shell and the lower shell subjected to the hydraulic transfer and joining them together.
